(19) United States
(12) Patent Application Publication
(10) Pub. No.: US 2022/0155858 A1
(43) Pub. Date: May 19, 2022

(54) DEVICE INTERACTION METHOD BASED ON ATTENTION DIRECTION

(71) Applicant: REALTEK SEMICONDUCTOR CORP., Hsinchu (TW)

(72) Inventors: Yi-Hsuan Huang, Hsinchu (TW); Wen-Tsung Huang, Hsinchu (TW)

(73) Assignee: REALTEK SEMICONDUCTOR CORP., Hsinchu (TW)

(21) Appl. No.: 17/186,454

(22) Filed: Feb. 26, 2021

(30) Foreign Application Priority Data
Nov. 16, 2020 (TW) 109139983

(51) Int. Cl. G06F 3/01; G06T 7/73; G06K 9/00; G06F 3/14

(52) U.S. Cl. CPC G06F 3/013; G06T 7/73; G06T 2207/20081; G06F 3/1423; G06T 2207/30201; G06K 9/00268

(57) ABSTRACT

A device interaction method based on an attention direction is provided. The method includes: capturing an input image of a target; determining a plurality of facial features of the target based on the input image; determining an attention angle of the target relative to a reference direction according to the facial features; determining an angle range threshold corresponding to a first display screen relative to the reference direction according to information carrying a distance between the target and the first display screen; determining whether the attention angle matches the angle range threshold; and when the attention angle matches the angle range threshold, determining that an attention direction of the target is directed toward the first display screen and performing a first action, and when the attention angle fails to match the angle range threshold, determining that the attention direction is directed toward a second display screen and performing a second action.

### CROSS-REFERENCE TO RELATED APPLICATION

This non-provisional application claims priority under 35 U.S.C. § 119(a) to Patent Application No. 109139983 filed in Taiwan, R.O.C. on Nov. 16, 2020, the entire contents of which are hereby incorporated by reference.

### BACKGROUND

### Technical Field

The present disclosure relates to a human-device interaction method based on direction of attention.

### Related Art

With the advancement of technologies, requirements for interaction between people and electronic products have been greatly improved. Human-machine interaction can be achieved through various input devices such as a keyboard or a mouse, and people can interact with a plurality of devices at the same time, in order to improve work efficiency or enjoy a plurality of entertainments. However, in a human-machine interaction scenario, complex control actions could cause low efficiency and users could show a lack of willingness to use the devices. For example, in a case that the user is working or relaxing with multiple screens, switching/setting among different windows ort screens, could greatly reduce the user experience and cause inconveniences.

### SUMMARY

In some embodiments, a device interaction method based on an attention direction includes: capturing an input image of a target; determining a plurality of facial features of the target based on the input image; determining an attention angle of the target relative to a reference direction according to the facial features; determining an angle range threshold corresponding to a first display screen relative to the reference direction according to information carrying a distance between the target and the first display screen; determining whether the attention angle matches the angle range threshold; and when the attention angle matches the angle range threshold, determining that the attention direction of the target is directed toward the first display screen and performing a first action; and when the attention angle fails to match the angle range threshold, determining that the attention direction is directed toward a second display screen and performing a second action.

### BRIEF DESCRIPTION OF THE DRAWINGS

FIG. 1 is a schematic block diagram of an embodiment of an electronic device to which a device interaction method based on an attention direction according to the present disclosure is applied.

FIG. 2 is a schematic diagram of an embodiment of an application scenario of a device interaction method based on an attention direction according to the present disclosure.

FIG. 3 is a flowchart of an embodiment of an attention direction determining method according to the present disclosure.

FIG. 4A is a schematic diagram of an embodiment in which an attention direction of a target directs toward a first display device.

FIG. 4B is a schematic diagram of an embodiment in which an attention direction of a target directs toward a second display device.

FIG. 4C is a schematic diagram of an embodiment in which an attention direction of a target directs toward a third display device.

FIG. 5 is a schematic curve diagram of an embodiment of directional angles corresponding to different first vertical distances and second vertical distances.

### DETAILED DESCRIPTION

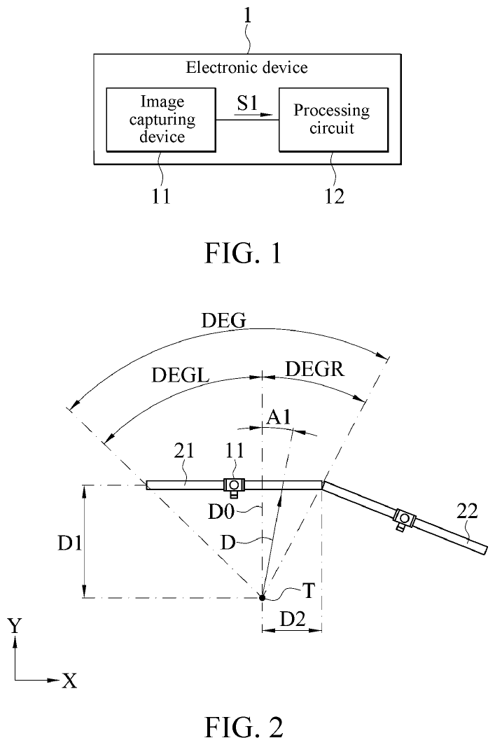

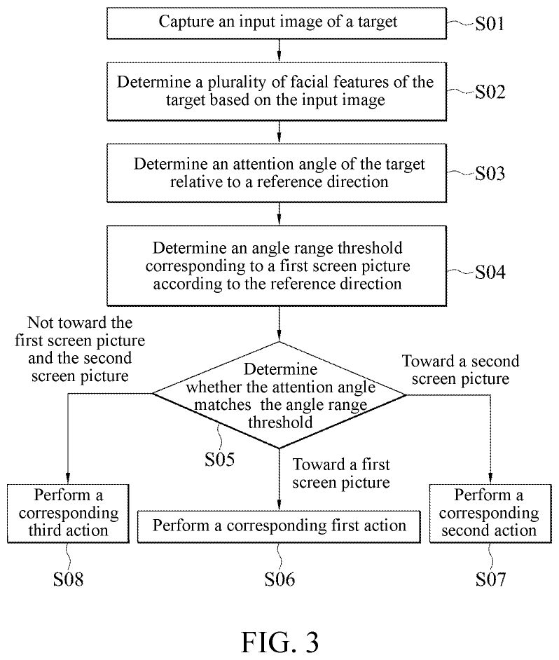

FIG. 1 is a schematic block diagram of an embodiment of an electronic device to which a device interaction method based on an attention direction according to the present disclosure is applied. FIG. 2 is a schematic diagram of an embodiment of an application scenario of a device interaction method based on an attention direction according to the present disclosure. Referring to FIG. 1 and FIG. 2 together, an electronic device 1 includes an image capturing device 11 and a processing circuit 12. The image capturing device 11 is coupled to the processing circuit 12. An example in which a first display device 21 displays a first display screen and a second display device 22 displays a second display screen is used for description. If a target T is located in front of the first display device 21 and the second display device 22, the image capturing device 11 may capture an input image S1 of the target T, and the input image S1 is a digital image. In the present invention, types of formats of the digital image may be, but is not limited to, an RGB image, or may be a CMYK, HSV (hue, saturation, value), HSI (hue, saturation, intensity), HSL (hue, saturation, lightness), HSB (hue, saturation, brightness), YCbCr, CIE XYZ, CIE Lab, or YUV (luminance, chrominance, chroma) image, or a digital image of another type of color gamut.

The image capturing device 11 may transmit the input image S1 to the processing circuit 12, and the processing circuit 12 may determine, based on the input image S1, whether an attention direction D of the target T is directed toward the first display screen on the first display device 21. FIG. 2 represents a top view that the target T is located at the center of a circle, and the target T can rotate toward his/her right-hand/left-hand side. A viewing direction (i.e., the attention direction D in FIG. 2) of the target T is shown with a projection line from the top view. Actually, the attention direction D may include a variable in a horizontal direction and a variable in a vertical direction. If the processing circuit 12 determines that the attention direction D is not directed toward the first display screen of the first display device 21, the processing circuit 12 may determine the following two cases: (1) the attention direction D is directed toward the second display screen of the second display device 22; or (2) the attention direction D is directed toward neither of the display screen of the first display device 21 nor the display screen of the second display device 22. Therefore, the processing circuit 12 may actuate a device corresponding to the direction of the attention direction D.

It is noted that, an example in which the independent first display device 21 and the second display device 22 respectively display the first display screen and the second display screen (e.g., the second display screen may show an extension window of the first display screen) is used in FIG. 2, but the present disclosure is not limited thereto. The first display screen and the second display screen may refer to different display regions on the same independent screen. That is, the present disclosure may be applicable to a case of a single screen including different display regions. In some embodiments, the first display device 21 and the second display device 22 may be liquid crystal displays, and the electronic device 1 may be a notebook computer, a mobile phone, a tablet computer or a desktop computer, but is not limited thereto.

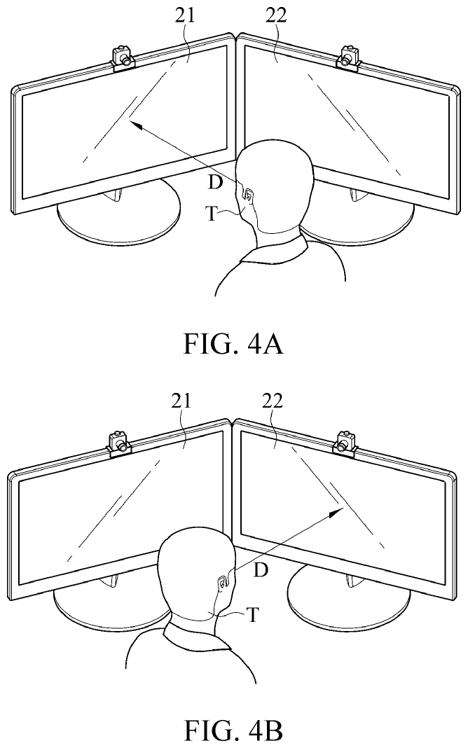

Referring to FIGS. 1-3. After the processing circuit 12 receives the input image S1 of the target T captured by the image capturing device 11 (i.e., step S01 in FIG. 3), the processing circuit 12 determines a plurality of facial features of the target T based on the input image S1 (step S02), to locate a face of the target T in the input image S1, and the processing circuit 12 further determines an attention angle A1 between the attention direction D and a reference direction D0 according to the facial features in the input image S1 (step S03), that is, the processing circuit 12 determines, based on a facing direction of the target T, a right deviation or a left deviation that the attention direction D of the target T is deviated from the preset reference direction D0.

To determine whether the attention direction D is directed toward the first display screen, the processing circuit 12 further determines the angle range threshold DEG corresponding to the first display screen according to the reference direction D0 (step S04), the angle range threshold DEG relates to information carrying a distance between the target T and the first display screen. For example, if a relative distance between the target T and the first display screen is longer, the angle range threshold DEG corresponding to the first display screen is relatively smaller; and if a relative distance between the target T and the first display screen is shorter, the angle range threshold DEG corresponding to the first display screen is relatively larger.

Therefore, in step S04, the processing circuit 12 determines the angle range threshold DEG corresponding to the first display screen according to the reference direction D0 and the information carrying the distance between the target T and the first display screen. After the attention angle A1 and the angle range threshold DEG are obtained, the processing circuit 12 determines whether the attention angle A1 matches the angle range threshold DEG, to recognize the attention direction D of the target T (step S05).

When the attention angle A1 matches the angle range threshold DEG (according to FIG. 2, it may be understood that when the line of the attention direction D falls within the area of the angle range threshold DEG), it indicates that the attention direction D is directed toward the first display screen displayed on the first display device 21. When the attention angle A1 fails to match the angle range threshold DEG (according to FIG. 2, it may be understood that when the line of the attention direction D falls outside the area of the angle range threshold DEG), it indicates that the attention direction D is directed toward the second display screen displayed on the second display device 22, or the attention direction D is not directed toward any of the first display screen and the second display screen. Then the processing circuit 12 actuates the corresponding device based on whether the attention direction D is directed toward the first display screen, the second display screen, or neither of them.

For example, if the attention direction D is directed toward the first display screen, the processing circuit 12 performs a first action (step S06). The processing circuit 12 may be coupled to the first display device 21 and the second display device 22 in a wired or wireless manner, and in step S06, adjusts display brightness of the second display device 22, to decrease the display brightness of the second display screen, or shuts down the second display device 22 to turn off the second display screen. The foregoing combination of actions for devices is defined as a first action, and actually, there may be different combinations of devices and actions according to different application fields. In step S06, the processing circuit 12 may also display the window and the mouse operated by the target T in the first display screen, and the processing circuit 12 may send a signal indicating the window and the mouse to the first display device 21, to facilitate the target T to operate the window and the mouse.

In some embodiments, when the first image capturing device (e.g., the image capturing device 11) and the second image capturing device (which is not labeled with a reference number in FIG. 2) are respectively placed at the first display device 21 and the second display device 22, in step S06, the processing circuit 12 may start the first image capturing device, and shut down the second image capturing device, to facilitate the target T to operate the first image capturing device and reduce power consumption of the second image capturing device. Otherwise, if the attention direction D is directed toward the second display screen, the processing circuit 12 performs a second action (step S07).

In step S07, the processing circuit 12 may adjust display brightness of the first display device 21 to decrease display brightness of the first display screen, or shut down the first display device 21 to turn off the first display screen. The processing circuit 12 may also send the signal indicating the foregoing window and the mouse to the second display device 22, so that the window and the mouse operated by the target T are displayed in the second display screen, to facilitate the target T to operate the window and the mouse. Alternatively, in step S07, the processing circuit 12 may start the second image capturing device, and shut down the first image capturing device, to facilitate the target T to operate the second image capturing device and reduce power consumption of the first image capturing device. On the other hand, if the attention direction D is not directed toward the first display screen and the second display screen, the processing circuit 12 may perform a third action (step S08). The processing circuit 12 may adjust the display brightness of the first display device 21 and the second display device 22 to decrease the display brightness of the first display screen and the second display screen, or the processing circuit 12 may shut down the first display device 21 and the second display device 22 to turn off the first display screen and the second display screen.

Therefore, the electronic device 1 may repeatedly perform steps S01-S05 to determine changes of the attention direction D of the target T s. When the attention direction D changes, the processing circuit 12 may further perform the action step S06, S07 or S08, to shut down the first display device 21 and start the second display device 22, or start the first display device 21 and shut down the second display device 22, and switch a window position and a mouse position from the first display screen to the second display screen, or switch the window position and the mouse position from the second display screen to the first display screen, and shut down the first image capturing device and start the second image capturing device, or start the first image capturing device and shut down the second image capturing device, or zoom-in/zoom-out/increase brightness/decrease brightness to display a specific window or content in the second display screen or the first display screen. It is understood that, the foregoing contents, combinations, and chain reactions are merely used for describing and are not intended to limit the scope of the present disclosure.

Based on this, the processing circuit 12 may automatically control the first display device 21, the second display device 22, the window position and the mouse position, and the foregoing two image capturing devices correspondingly according to the attention direction D. When there are a plurality of screens, the user does not need to manually drag the window position and move the mouse position among a plurality of screens, and the user does not need to manually adjust display settings of the plurality of screens, thereby improving operation convenience, reducing power consumptions and increasing information security.

In some embodiment, in step S02, the processing circuit 12 may perform a histogram of oriented gradients (HOG) algorithm to locate a face and eyes, to determine a plurality of facial features of the target T. Furthermore, because a plurality of input images S1 of the target T that are captured by the image capturing device 11 at different time points may have different color brightness and backcolors, the processing circuit 12 may perform smoothing process on the plurality of input images S1 by using an optical flow method according to the plurality of input images S1 of the target T that are captured by the image capturing device 11 at different time points, in order to locate a stable face position and stable eye positions.

In some embodiments, the attention angle A1 may be a head orientation angle having three-dimensional angle information. In step S03, the processing circuit 12 may make an estimation based on a result obtained by a detection model of a facial feature point determined in step S02, projects a plurality of two-dimensional coordinate points on an image to three-dimensional coordinate points of a preset average three-dimensional face model by using an internal parameter of the image capturing device 11, and calculates three-dimensional coordinates of the face of the target T on the input image S1 based on the projection. In a calculation process, the processing circuit 12 obtains a rotation matrix converted through projection. The rotation matrix may be a converted matrix of unit quaternions and Euler angles, and the processing circuit 12 generates the head-orientated three-dimensional angle information as the attention angle A1.

In some embodiments, the attention angle A1 may be a viewing direction angle having two-dimensional vector information. In step S03, the processing circuit 12 may perform an image recognition algorithm. When the processing circuit 12 performs the image recognition algorithm, a displacement vector of the eyeballs of the target T in the input image S1 may be recognized according to preset eyeball positions, to locate eyeball positions of the target T in the input image S1. In some embodiments, the preset eyeball position is a digital image with the eyeball position captured by the image capturing device 11 for the target T when the device interaction method of the present invention is performed. According to the digital image and the eyeball position being captured in the beginning, the processing circuit 12 defines the position as a preset eyeball position. In some embodiments, the preset eyeball position may be an average eyeball position that is stored in a specific database (e.g., a cloud database) and obtained through analysis/statistics based on one or more targets (e.g., faces collected from various places). However, the preset eyeball position is not limited to the foregoing embodiments.

Alternatively, in step S03, the processing circuit 12 may also perform a deep learning process, and make an estimation by using a deep learning model architecture. In a learning phase, an input of the deep learning model is a plurality of eye region images and eyeball positions in a plurality of face region images for use of learning. After performing deep learning process according to learning materials, the processing circuit 12 generates a learning result, and stores the learning result. When the processing circuit 12 determines the attention angle A1, the processing circuit 12 determines the eyeball positions in the input image S1 according to the learning result, and generates a two-dimensional vector to represent the viewing direction angle. The two-dimensional vector includes an angle of the viewing direction along an X-axis and an angle of the viewing direction along a Y-axis. The deep learning model may be a convolutional neural network (CNN) architecture, and the processing circuit 12 may extract eye feature points by using a plurality of CNNs, to output the viewing direction angle as the attention angle A1.

In some embodiments, the attention angle A1 may include the head orientation angle and the viewing direction angle, and the processing circuit 12 may combine the head orientation angle and the viewing direction angle to calculate the attention angle A1 corresponding to the attention direction D.

In some embodiments, the first display device 21 and the second display device 22 may be substantially placed adjacently along an X-axis or a Y-axis. FIG. 2 shows an example in which the first display device 21 and the second display device 22 are substantially placed adjacently along the X-axis direction and there is an angle between the first display device 21 and the second display device 22. As shown in FIG. 2, the first display device 21 includes a side (which is referred to as a first side below) that is close to the second display device 22 and a side (which is referred to as a second side below) that is far away from the second display device 22. The target T faces the first display device 21. The image capturing device 11 may be placed at the first display device 21 to capture an input image S1 of the target T. Based on this, according to a relative position between the target T and the first display device 21, a reference direction D0 may refer to a direction extending through the target T and is perpendicular to the first display device 21. The information carrying the distance between the target T and the first display device 21 may include a first vertical distance D1 and a second vertical distance D2, the first vertical distance D1 is a vertical distance (i.e., a vertical distance between the target T and the first display device 21) extending from the target T to the first display device 21 along the reference direction D0, and the second vertical distance D2 is a vertical distance between a vertical projection of the target T on the first display device 21 along the reference direction D0 and the first side of the first display device 21. Mostly, the image capturing devices are provided on top of the first display device. Therefore, when the first vertical distance D1 is calculated, the processing circuit 12 may directly take the distance between the first display device 21 and the target T as the first vertical distance D1.

Furthermore, based on the reference direction D0, as shown in FIG. 2, the angle range threshold DEG includes a first directional angle DEGR and a second directional angle DEGL. In this embodiment, relative to the reference direction D0 based on the target T to the first display device 21, the first directional angle DEGR is located at a right side of the reference direction D0, and the second directional angle DEGL is located at a left side of the reference direction D0. The first display device 21, the reference direction D0, and an extension direction from the target T to the first side of the first display device 21 form a right triangle (which is referred to as a right-side triangle below) together. The first display device 21, the reference direction D0, and an extension direction from the target T to the second side of the first display device 21 form another right triangle (which is referred to as a left-side triangle below) together. In step S04, based on the right-side triangle, the processing circuit 12 may determine, according to the first vertical distance D1 and the second vertical distance D2, the first directional angle DEGR that deviates from the right side of the reference direction D0. Moreover, based on the left-side triangle, the processing circuit 12 may determine, according to the first vertical distance D1 and a vertical distance between the vertical projection of the target T on the first display device 21 and the second side, the second directional angle DEGL deviates from the left side of the reference direction D0.

After the first directional angle DEGR and the second directional angle DEGL are determined, the processing circuit 12 compares the first directional angle DEGR the second directional angle DEGL and the attention angle A1 that is deviated from the right side or left side of the reference direction D0 in step S05. In the present invention, the target T is located at the center of a circle, the reference direction D0 is used as a starting point, a clockwise direction in FIG. 2 may generate a positive angle, and a counterclockwise in direction FIG. 2 may generate a negative angle. In step S05, the processing circuit 12 may determine whether the attention angle A1 is equal to the first directional angle DEGR or the attention angle A1 falls between the first directional angle DEGR and the second directional angle DEGL (i.e., the angle range threshold DEG).

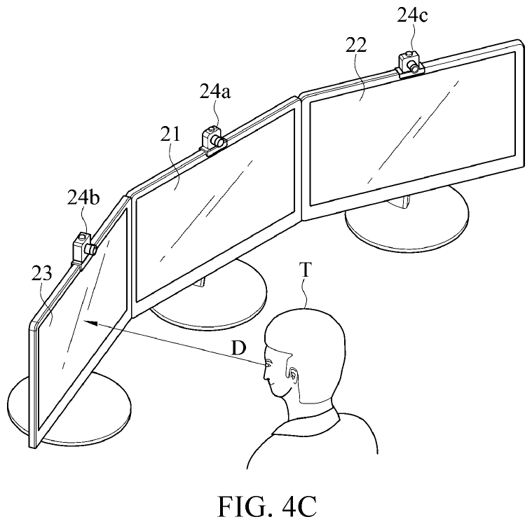

When the attention angle A1 is greater than the first directional angle DEGR, in step S05, the processing circuit 12 determines that the attention direction D of the target T is directed toward the second display device 22. When the attention angle A1 falls between the first directional angle DEGR or the second directional angle DEGL, in step S05, the processing circuit 12 determines that the attention direction D of the target T is directed toward the first display device 21. In some embodiments, if a third display device 23 (referring to FIG. 4C) is disposed at a left side of the first display device 21, and when the attention angle A1 is equal to the second directional angle DEGL, in step S05, the processing circuit 12 may determine that the attention direction D of the target T is directed toward the third display device.

For example, a width of the first display device 21 may be 17.95 cm, the first vertical distance D1 may be 27 cm, the second vertical distance D2 may be 10 cm, the first directional angle DEGR may be 19°, and the second directional angle DEGL may be −43°. If the attention angle A1 is 2°, the processing circuit 12 has obtained that the first directional angle DEGR is 19° and the second directional angle DEGL is −43°. The processing circuit 12 may determine that the attention angle A1(2°) falls between the first directional angle DEGR (19°) and the second directional angle DEGL)(−43°.

Based on this, the processing circuit 12 may determine that the attention direction D of the target T is directed toward the first display device 21, as shown in FIG. 4A. If the attention angle A1 is 25°, the attention angle A1(25°) is greater than the first directional angle DEGR (19°). The processing circuit 12 determines that the attention direction D of the target T is directed toward the second display device 22, as shown in FIG. 4B. If the attention angle A1 is −50°, the attention angle A1)(−50° is equal to the second directional angle DEGL)(−43°. The processing circuit 12 may determine that the attention direction D of the target T is directed toward the left side of the first display device 21. Based on the foregoing third display device 23 case, if the third display device 23 is disposed at the left side of the first display device 21, and the attention angle A1 is −50°, the target T may be considered as viewing the third display device 23, as shown in FIG. 4C.

As shown in FIG. 4C, when the target T views the first display device 21, a first image capturing device 24a performs image capturing and the processing circuit 12 performs a corresponding calculation. If the attention angle A1 of the target T is 25°, the processing circuit 12 may switch an image of the first display device 21 to the second display device 22, and start a second image capturing device 24b and shut down the first image capturing device 24a. Similarly, if the attention angle A1 of the target T is −50°, the processing circuit 12 may switch the image of the first display device 21 to the third display device 23, and start a third image capturing device 24c and shut down the first image capturing device 24a.

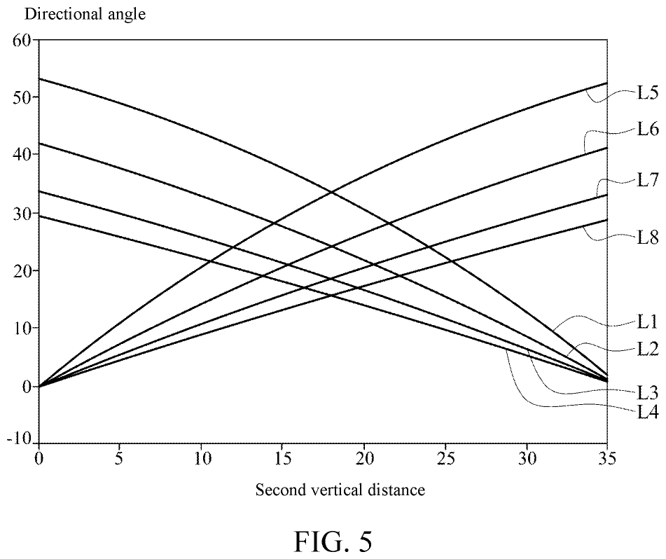

In some embodiments, according to different positions of the target T, there is an inverse proportion relationship between the first vertical distance D1 and absolute values of the first directional angle DEGR and the second directional angle DEGL, and there is also an inverse relationship between the second vertical distance D2 and the absolute values of the first directional angle DEGR and the second directional angle DEGL. As shown in FIG. 5, a horizontal axis represents the second vertical distance D2, and a vertical axis represents the absolute values of the first directional angle DEGR and the second directional angle DEGL. A curve L1 represents a plurality of second directional angles DEGL corresponding to the first vertical distance D1 fixed at 27 cm and a plurality of second vertical distances D2 between 0 cm and 35 cm. A curve L2 represents a plurality of second directional angles DEGL corresponding to the first vertical distance D1 fixed at 40 cm and the plurality of second vertical distances D2 between 0 cm and 35 cm. A curve L3 represents a plurality of second directional angles DEGL corresponding to the first vertical distance D1 fixed at 54 cm and the plurality of second vertical distances D2 between 0 cm and 35 cm. A curve L4 represents a plurality of second directional angles DEGL corresponding to the first vertical distance D1 fixed at 64 cm and the plurality of second vertical distances D2 between 0 cm and 35 cm. A curve L5 represents a plurality of first directional angles DEGR corresponding to the first vertical distance D1 fixed at 27 cm and the plurality of second vertical distances D2 between 0 cm and 35 cm. A curve L6 represents a plurality of first directional angles DEGR corresponding to the first vertical distance D1 fixed at 40 cm and the plurality of second vertical distances D2 between 0 cm and 35 cm. A curve L7 represents a plurality of first directional angles DEGR corresponding to the first vertical distance D1 fixed at 54 cm and the plurality of second vertical distances D2 between 0 cm and 35 cm. A curve L8 represents a plurality of first directional angles DEGR corresponding to the first vertical distance D1 fixed at 64 cm and the plurality of second vertical distances D2 between 0 cm and 35 cm. The inverse proportion relationships may be learned from FIG. 5.

In some embodiments, in step S04, after the input image S1 is obtained, the processing circuit 12 may perform image analysis based on the input image S1 to automatically determine the first vertical distance D1, and calculate the second vertical distance D2 according to a preset width of the first display device 21, that is, the processing circuit 12 may determine a corresponding first directional angle DEGR and a corresponding second directional angle DEGL according to actual variable vertical distances D1 and D2, and then determine, based on the first directional angle DEGR and the second directional angle DEGL, that the attention direction D is toward the first display device 21 or the second display device 22. Alternatively, the first vertical distance D1 and the second vertical distance D2 may also be a preset fixed value. That is, the target T can only be at a fixed preset position. Therefore, in step S04, the processing circuit 12 may calculate the corresponding first directional angle DEGR and the corresponding second directional angle DEGL according to the first vertical distance D1 and the second vertical distance D2 by using a mathematical algorithm. Alternatively, correspondences between the first vertical distance D1 and the second vertical distance D2 and the first directional angle DEGR and the second directional angle DEGL may be generated in advance and stored in the electronic device 1. When the device interaction method based on the attention direction D is performed, the processing circuit 12 then obtains, by using a look-up table method, a corresponding first directional angle DEGR and a corresponding second directional angle DEGL according to a first vertical distance D1 and a second vertical distance D2 that are obtained through actual determining or a preset first vertical distance D1 and a preset second vertical distance D2.

Based on the above, according to an embodiment of a device interaction method based on an attention direction of the present disclosure, this method may be widely applied to electronic products having image capture devices. Through the method, display settings among a plurality of screens and devices having different screen settings are automatically controlled according to attention directions, so that a user does not need to perform the settings and control in a manual manner, thereby improving operation convenience, and reducing unnecessary power consumptions and increasing information security.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A device interaction method based on an attention direction:
capturing an input image of a target;
determining a plurality of facial features of the target based on the input image;
determining an attention angle of the target relative to a reference direction according to the facial features;
determining an angle range threshold corresponding to a first display screen relative to the reference direction according to information carrying a distance between the target and the first display screen;
determining whether the attention angle matches the angle range threshold;
determining, when the attention angle matches the angle range threshold, that the attention direction of the target is directed toward the first display screen and performing a first action; and
performing a second action according to the attention direction when the attention angle fails to match the angle range threshold.

2. The device interaction method based on the attention direction according to claim 1, wherein the attention angle comprises a head orientation angle and a viewing direction angle, wherein the step of determining the attention angle comprises:
locating the head of the target according to the facial features, to determine the head orientation angle;
locating an eyeball position of the target according to the facial features; and
determining the viewing direction angle along a two-dimensional direction according to the eyeball position.

3. The device interaction method based on the attention direction according to claim 2, wherein the step of locating the eyeball position comprises: determining a displacement of an eyeball of the target according to a preset eyeball position, in order to locate the eyeball position.

4. The device interaction method based on the attention direction according to claim 2, wherein the step of locating the eyeball position comprises:
performing a deep learning process according to a plurality of eye region images and eyeball positions in a plurality of face region images before capturing the input image, in order to generate a learning result; and
locating the eyeball position according to the learning result.

5. The device interaction method based on the attention direction according to claim 1, wherein the first display screen is displayed on a first display device, a second display screen is displayed on a second display device, and the first display device comprises a side adjacent to the second display device, wherein the information carrying the distance comprises a first vertical distance between the target and the first display device and a second vertical distance between a vertical projection of the target on the first display device and the side.

6. The device interaction method based on the attention direction according to claim 5, wherein the angle range threshold comprises a first directional angle and a second directional angle, the first directional angle is a deviation corresponding to a first side of the reference direction, and the second directional angle is a deviation corresponding to a second side of the reference direction, wherein the step of determining that the attention angle matches the angle range threshold comprises:
determining, when the attention angle falls between the first directional angle and the second directional angle, that the attention direction is directed toward the first display screen; and
the step of determining that the attention angle fails to match the angle range threshold comprises:
determining, when the attention angle is greater than the first directional angle or is equal to the second directional angle, that the attention direction is directed toward the second display screen.

7. The device interaction method based on the attention direction according to claim 1, wherein the first action comprises turning off a second display screen, the second action comprises turning off the first display screen, and the device interaction method further comprises:
turning off the first display screen and the second display screen when the attention direction is not directed toward both of the first display screen and the second display screen.

8. The device interaction method based on the attention direction according to claim 1, further comprising:
controlling, when the attention direction is directed from the first display screen to a second display screen, a mouse position or a window position to be switched from the first display screen to the second display screen; and
controlling, when the attention direction is directed from the second display screen to the first display screen, the mouse position or the window position to be switched from the second display screen to the first display screen.

9. The device interaction method based on the attention direction according to claim 1, wherein the first action comprises starting a first image capturing device corresponding to the first display screen, and shutting down a second image capturing device corresponding to a second display screen, and the second action comprises starting the second image capturing device and shutting down the first image capturing device.

10. The device interaction method based on the attention direction according to claim 1, wherein the first action comprises decreasing brightness of a second display screen, and the second action comprises decreasing brightness of the first display screen.
